(19) United States
(12) Patent Application Publication
(10) Pub. No.: US 2026/0310113 A1
(43) Pub. Date: Oct. 8, 2026

(54) POSITIVELY CHARGEABLE TONER AND TWO-COMPONENT DEVELOPER CONTAINING POSITIVELY CHARGEABLE TONER

(71) Applicant: KYOCERA Document Solutions Inc., Osaka (JP)

(72) Inventors: Masanori SUGAHARA, Osaka (JP); Masashi YAMASHITA, Osaka (JP); Ryo YAMADA, Osaka (JP)

(73) Assignee: KYOCERA Document Solutions Inc., Osaka (JP)

(21) Appl. No.: 19/638,814

(22) Filed: Apr. 3, 2026

(30) Foreign Application Priority Data
Apr. 8, 2025 (JP) 2025-063878

(51) Int. Cl. G03G 9/093; G03G 9/087; G03G 9/113

(52) U.S. Cl. CPC G03G 9/09321; G03G 9/08755; G03G 9/1135

(57) ABSTRACT

Positively chargeable toner contains a toner base particle to the surface of which are attached a first, and a second, resin fine particle with a number average primary particle size of 60 nm or more but 100 nm or less, and 30 nm or more but 50 nm or less. The first and second resin fine particles have a hardness of 1 μN or more. The first, and the second, resin fine particle has an SP value of 9.42 or more but 9.80 or less, and 8.70 or more but 9.40 or less, a degree of hydrophobization of 5% or more but 16% or less, and 18% or more, and a coverage ratio with respect to the surface region of the toner base particle of 5% or more, and 5% or more but 25% or less.

### INCORPORATION BY REFERENCE

This application is based on and claims the benefit of priority from Japanese Patent Application No. 2025-063878 filed on Apr. 8, 2025, the contents of which are hereby incorporated by reference.

### BACKGROUND

The present disclosure relates to positively chargeable toner for use in development of an electrostatic latent image and two-component developer containing such positively chargeable toner.

In general, in electrophotography, the surface of an electrostatic latent image carrying member is electrostatically charged by corona discharge or the like and is then exposed to laser light or the like to form an electrostatic latent image. The formed electrostatic latent image is developed with toner to form a toner image. The formed toner image is then transferred to a recording medium to obtain a high-quality image. Typically, as toner for use in such electrophotography, a binder resin such as a thermoplastic resin is blended with a colorant, a charge control agent, a release agent, and the like and the mixture is then subjected to kneading, pulverization, and classification to obtain toner particles (toner base particles). Then, for the purposes of giving the toner fluidity, giving it satisfactory charging properties, and improving the cleaning properties of the toner against a photosensitive drum, an inorganic fine powder such as silica or titanium oxide is externally added to the toner base particles.

An external additive on the surface of toner sinks, comes off, or otherwise changes under mechanical stress caused by being stirred in a developing unit. One generally known method of suppressing the change such as sinking in and coming-off of the external additive is to use an external additive with a large diameter as spacer particles.

### SUMMARY

According to one aspect of the present disclosure, positively chargeable toner has toner particles each including a toner base particle and an external additive attached to the surface of the toner base particle. The external additive contains a first resin fine particle with a number average primary particle size of 60 nm or more but 100 nm or less and a second resin fine particle with a number average primary particle size of 30 nm or more but 50 nm or less. The first and second resin fine particles have a hardness of 1 μN or more as observed with a probe displacement of 40 nm. The first resin fine particle has an SP value of 9.42 or more but 9.80 or less, a degree of hydrophobization of 5% or more but 16% or less, and a coverage ratio with respect to the surface region of the toner base particle of 5% or more. The second resin fine particle has an SP value of 8.70 or more but 9.40 or less, a degree of hydrophobization of 18% or more, and a coverage ratio with respect to the surface region of the toner base particle of 5% or more but 25% or less.

### BRIEF DESCRIPTION OF THE DRAWINGS

FIG. 1 is a diagram showing one example of the sectional structure of positively chargeable toner according to the present disclosure for use in two-component developer.

### DETAILED DESCRIPTION

A description will be given below of an embodiment according to the present disclosure. Unless otherwise defined, a result of evaluation (i.e., a value related to a shape, property, or the like) with respect to a powdery substance (specifically, toner core particle, toner base particle, external additive, toner, and the like) is given as a number average of values obtained by measuring respectively for an appropriate number of average particles selected from the powdery substance. Unless otherwise defined, a measured value of the number average primary particle size of a powdery substance or the volume median diameter (D50) of a powdery substance is a value measured using a Multisizer 4 (manufactured by Beckman Coulter, Inc.). Unless otherwise defined, a measured value of an acid number or a hydroxy group number is a value measured in conformity with JIS (Japanese Industrial Standards) K0070-1992. Unless otherwise defined, a measured value of a number average molecular weight (Mn) or a mass average molecular weight (Mw) is a value measured by gel permeation chromatography.

Unless otherwise defined, a softening point (Tm) is a value measured using a polymer flow tester (CFT-500D, manufactured by Shimadzu Corporation). In an S-shaped curve (horizontal axis: temperature, vertical axis: stroke) plotted using the polymer flow tester, a temperature equal to (baseline stroke value+maximum stroke value)/2 corresponds to Tm (softening point). Unless otherwise defined, a measured value of a melting point (Mp) is a temperature at the maximum endothermic peak in an endothermic curve (vertical axis: heat flow (a DSC signal), horizontal axis: temperature) plotted using a differential scanning calorimeter (DSC-6220, manufactured by Seiko Instruments Inc.). This endothermic peak results from the melting of a crystallized portion. Unless otherwise defined, a glass transition point (Tg) is a value measured in conformity with JIS (Japanese Industrial Standards) K7121-2012 using a differential scanning calorimeter (DSC-6220, manufactured by Seiko Instruments Inc.). In an endothermic curve (vertical axis: heat flow (a DSC signal), horizontal axis: temperature) plotted using the differential scanning calorimeter, a temperature at an inflection point ascribable to a glass transition (specifically, a temperature at the intersection between a line extrapolated from the baseline and a line extrapolated from the falling line) corresponds to Tg (glass transition point).

An SP value (solubility parameter) is a parameter defined using the formula “SP value=(E/V)^{1/2}” (E: agglomeration energy [cal/mol], V: molar volume [cm³/mol]), being, unless otherwise defined, a value (unit: [(cal/cm³)^{1/2}], temperature: 25° C.) calculated by the Fedors Method. Note that a detailed discussion of the Fedors Method is found in “R. F. Fedors, “Polymer Engineering and Science,” 1974, vol. 14 (2), p. 147-154.”

In the following description, “-based” is occasionally appended to the name of a compound to collectively refer to that substance and their derivatives. Whenever the name of a compound has “-based” appended to it to refer to the name of a polymer, the repeating unit in the polymer is derived from any of that compound and their derivatives. The term “(meth)acrylic” is occasionally used to refer to “acrylic” and “methacrylic” collectively. The term “(meth)acryloyl” is occasionally used to refer to “acryloyl” (CH₂═CH—CO—) and “methacryloyl” (CH₂═C(CH₃)—CO—) collectively.

Toner according to the embodiment can be used as positively chargeable toner suitably for development of electrostatic latent images. The toner according to the embodiment is a powdery substance containing a plurality of toner particles (each a particle configured as described later). The toner according to the embodiment is mixed with carrier using a mixing apparatus (e.g., a ball mill) to prepare two-component developer. To form high-quality images, it is preferable to use ferrite carrier as the carrier.

To form high-quality images over a long period, it is preferable to use magnetic carrier particles that have a carrier core and a resin layer coating the carrier core. To produce magnetic carrier particles, the carrier core can be formed with a magnetic material (e.g., ferrite) or the carrier core can be formed with resin having magnetic particles dispersed in it. Or, magnetic particles can be dispersed in the resin layer coating the carrier core. To form high-quality images, the amount of toner in two-component developer is preferably 5 mass parts or more but 15 mass parts or less for 100 mass parts of carrier. Positively chargeable toner is charged positive by friction with carrier.

The toner particles of the toner according to the embodiment have a toner base particle and an external additive attached to the surface of the toner base particle. That is, the toner particle before the external additive attaches to it is referred to as toner base particle. If the toner base particle has a shell layer, the particle before the shell layer is formed on it is referred to as the toner core particle. If the toner base particle has no shell layer, the toner base particle alone is also referred to as the toner core particle.

The toner according to the embodiment can be used to form an image, for example, on an electrophotographic apparatus (image forming apparatus). One example of an image forming method on an electrophotographic apparatus will be described below.

First, based on image data, an electrostatic latent image is formed on a photosensitive member (e.g., a superficial part of a photosensitive drum). Next, the formed electrostatic latent image is developed with developer containing toner. In the development process, toner (e.g., toner electrostatically charged by friction with carrier or a blade) on a development sleeve (e.g., a superficial part of a development roller in the developing device) disposed near the photosensitive member is attached to the electrostatic latent image to form a toner image on the photosensitive member. In the subsequent transfer process, the toner image on the photosensitive member is directly transferred to a recording medium (e.g., sheet); or it is primarily transferred to an intermediate transfer member (e.g., a transfer belt) and then the toner image on the intermediate transfer member is secondarily transferred to the recording medium. Then, the toner is heated to fix the toner to the recording medium. As a result, an image is formed on the recording medium. By superposing on each other toner images of four colors, for example, black, yellow, magenta, and cyan, it is possible to form a full-color image.

### [1. Basic Configuration of Toner]

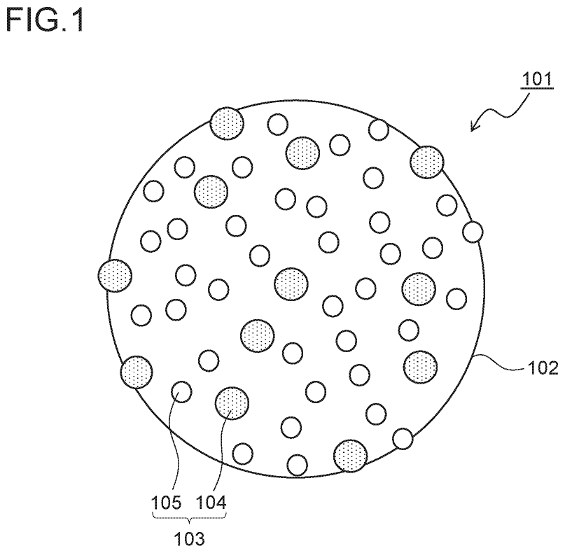

FIG. 1 is a diagram showing one example of the sectional structure of positively chargeable toner 101 according to the present disclosure. As shown in FIG. 1, the positively chargeable toner (hereinafter often referred to simply as toner) 101 according to the present disclosure has a toner base particle 102 and an external additive 103 attached to the surface of the toner base particle 102. The toner base particle 102 at least contains a binder resin and a colorant. The external additive 103 contains first resin fine particles 104 and second resin fine particles 105. The first and second resin fine particles 104 and 105 are used as spacer particles.

The first resin fine particles 104 have a number average primary particle size of 60 nm or more but 100 nm or less. If the first resin fine particles 104 have a number average primary particle size of less than 60 nm, they are easy to fix to the surface of the toner base particle 102 but are less effective as a spacer and thus less effective in preventing the sinking of the second resin fine particles 105 and other external additives. As a result, the sinking of the external additive promotes deterioration of toner and aggravates toner scattering and image density variation, making it impossible to form images stably.

On the other hand, if the first resin fine particles 104 have a number average primary particle size more than 100 nm, they are difficult to fix to the surface of the toner base particle 102 and more of them come off. As a result, in a nip portion (hereinafter often referred to also as the cleaning portion) between a photosensitive drum and a cleaning blade (neither is shown), an agglomeration of released first resin fine particles 104 pushes up the cleaning blade under the conveyance force, leading to poor cleaning. In addition, released first resin fine particles 104 can contaminate carrier or contaminate members in an image forming apparatus.

If the toner 101 contains little moisture, electrical conduction is poor between the carrier and the toner 101, leading to a slow rise of the charge amount. The first resin fine particles 104, which have a large particle size and easily make contact with the carrier, absorb water easily. This serves to increase the moisture contained in the toner 101 and quickens the rise of the charge amount. The first resin fine particles 104 need to have a degree of hydrophobization of 4% or more but 17% or less (a moisture absorbance of 2.0 to 3.6%). With a degree of hydrophobization less than 4%, while satisfactory electrical conduction can be achieved in a low humidity environment, the toner 101 contains too much moisture in a high humidity environment, leading to a reduced amount of charge. With a degree of hydrophobization more than 17%, the toner 101 contains little moisture, leading to poor electrical conductivity.

For the first resin fine particles 104 to serve to quicken the rise of the charge amount, they need to be fixed to the surface of the toner base particle 102. Thus, the first resin fine particles 104 have an SP value of 9.42 or more but 9.80 or less. With an SP value less than 9.42, the first resin fine particles 104 are difficult to fix under a shear mix energy during external addition treatment, and more of the first resin fine particles 104 come off the toner base particle 102, degrading charge transport properties. With an SP value more than 9.80, more of the first resin fine particles 104 tend to sink in the toner base particle 102, and the first resin fine particles 104 sink under physical stress in a development device during printing, degrading charge transport properties.

The presence of the second resin fine particles 105 prevents the first resin fine particles 104 from sinking in the toner base particle 102, ensuring effective charge transport. Using the second resin fine particles 105 with a particle size of 50% or more but 100% or less of that of the first resin fine particles 104 helps ensure effective charge transport. If the second resin fine particles 105 have a particle size less than 50% of that of the first resin fine particles 104, the second resin fine particles 105 sink in the toner base particle 102 under physical stress in the development device during printing, degrading charge transport properties. Preferably, the second resin fine particles 105 have a number average primary particle size of 30 nm or more but 50 nm or less.

For the first resin fine particles 104 to serve to transport charge, preferably, the second resin fine particles 105 is given low compatibility with the toner base particle 102. Here, in the toner 101 according to the present disclosure, the second resin fine particles 105 have an SP value of 8.70 or more but 9.40 or less. If the second resin fine particles 105 have an SP value less than 8.7, more of the second resin fine particles 105 come off the toner base particle 102, and thus they are less effective as a spacer. If the second resin fine particles 105 have an SP value more than 9.40, more of the second resin fine particles 105 tend to sink in the toner base particle 102 under physical stress in the development device during printing. As a result, the first resin fine particles 104 also sink in the toner base particle 102, degrading charge transport properties.

The second resin fine particles 105 are given a degree of hydrophobization of 18% or more. This allows the second resin fine particles 105 to maintain charge transported from the first resin fine particles 104 so as to serve to quicken the rise of the charge amount. If the second resin fine particles 105 have a degree of hydrophobization less than 18%, its volume resistance value is so low as to make it difficult to maintain charge in particular in an high humidity environment, resulting in a reduced toner charge amount.

The first and second resin fine particles 104 and 105 have a hardness of 1.0 μN or more (with a probe displacement of 40 nm). If the hardness is less than 1.0 μN, due to the insufficient hardness of the resin fine particles, the resin fine particles form a film on the surface of the photosensitive drum under stress at the nip portion between the photosensitive drum and the cleaning blade. This causes unstable stick-slip movement of the cleaning blade, leading to poor cleaning.

### [2. Material of Toner]

Next, a description will be given of the essential or optional components of the toner according to the present disclosure. The toner core particle contains, in the binder resin, at least a colorant. It can further contain, as necessary, a release agent, a charge control agent, a magnetic powder, and the like, and can have a shell layer formed on the surface of the toner core particle. In the toner according to the present disclosure, the toner core particle (toner base particle) has its surface treated with an external additive.

A description will be given below, one by one, of the binder resin, the release agent, the colorant, the charge control agent, and the magnetic powder that form the toner core particle, a shell material for cases where a shell layer is formed on the toner core particle, the external additive externally added to the toner core particle (tone base particle), and a method of producing the toner according to the present disclosure.

### (Binder Resin)

The toner core particle that forms the toner according to the present disclosure contains a binder resin. The binder resin that can be contained in the toner core particle is not particularly limited so long as it is a resin that is known to be used as a binder resin in toner. Specific examples of the binder resin include thermoplastic resins such as styrene-based resins, acrylic-based resins, styrene-acrylic-based resins, polyethylene-based resins, polypropylene-based resins, vinyl chloride-based resins, polyester resins, polyamide resins, polyurethane resins, polyvinyl alcohol-based resins, vinyl ether-based resins, N-vinyl-based resins, and styrene-butadiene resins. Among these resins, in terms of the dispersion properties of the colorant in the binder resin, the charging properties of the toner, and the fixing properties to sheets, a polyester resin is preferable. The polyester resin will be described below.

Usable as polyester resins are those obtained by condensation polymerization or condensation copolymerization of a dihydric or a trihydric or higher alcohol component and a divalent or a trivalent or higher carboxylic acid component. Examples of components used to synthesize a polyester resin include alcohol components or carboxylic acid components as mentioned below.

Specific examples of dihydric or trihydric or higher alcohol components include: diols such as ethylene glycol, diethylene glycol, triethylene glycol, 1,2-propylene glycol, 1,3-propylene glycol, 1,4-butanediol, neopentyl glycol, 1,4-butenediol, 1,5-pentanediol, 1,6-hexanediol, 1,4-cyclohexanedimethanol, dipropylene glycol, polyethylene glycol, polypropylene glycol, and polytetramethylene glycol; bisphenols such as bisphenol A, hydrogenated bisphenol A, polyoxyethylene bisphenol A, and polyoxypropylene bisphenol A; and trihydric or higher alcohols such as sorbitol, 1,2,3,6-hexanetetrol, 1,4-sorbitan, pentaerythritol, dipentaerythritol, tripentaerythritol, 1,2,4-butanetriol, 1,2,5-pentanetriol, glycerol, diglycerol, 2-methylpropanetriol, 2-methyl-1,2,4-butanetriol, trimethylolethane, trimethylolpropane, and 1,3,5-trihydroxymethylbenzene.

Specific examples of divalent or trivalent or higher carboxylic acid components include divalent carboxylic acids such as maleic acid, fumaric acid, citraconic acid, itaconic acid, glutaconic acid, phthalic acid, isophthalic acid, terephthalic acid, cyclohexane dicarboxylic acid, succinic acid, adipic acid, sebatic acid, azelaic acid, and malonic acid, and alkyl or alkenyl succinic acids such as n-butyl succinic acid, n-butenyl succinic acid, isobutyl succinic acid, isobutenyl succinic acid, n-octyl succinic acid, n-octenyl succinic acid, n-dodecyl succinic acid, n-dodecenyl succinic acid, isododecyl succinic acid, and isododecenyl succinic acid; and trivalent or higher carboxylic acids such as, 1,2,4-benzenetricarboxylic acid (trimellitic acid), 1,2,5-benzene tricarboxylic acid, 2,5,7-naphthalene tricarboxylic acid, 1,2,4-naphthalene tricarboxylic acid, 1,2,4-butanetricarboxylic acid, 1,2,5-hexanetricarboxylic acid, 1,3-dicarboxyl-2-methyl-2-methylenecarboxypropane, 1,2,4-cyclohexane tricarboxylic acid, tetra(methylene carboxyl) methane, 1,2,7,8-octane tetracarboxylic acid, pyromellitic acid, and empole trimer acid. These divalent or trivalent or higher carboxylic acid components may be used as ester-forming derivatives such as acid halides, acid anhydrides, and lower alkyl esters. Here, the term “lower alkyl” denotes an alkyl group with one to six carbon atoms.

When the binder resin is a polyester-based resin, the softening point of the polyester-based resin is preferably 70° C. or more but 130° C. or less, and more preferably 80° C. or more but 120° C. or less. For improved mechanical strength of the toner core particles and improved fixing properties of the toner, the number average molecular weight (Mn) of the polyester resin is preferably 1000 or more but 2000 or less. The molecular weight distribution of the polyester resin (the ratio Mw/Mn of mass average molecular weight (Mw) to number average molecular weight (Mn)) is preferably 9 or more but 21 or less.

As the binder resin, it is preferable to use a thermoplastic resin for its satisfactory fixing properties to sheets. Here, a thermoplastic resin can be used not only singly but also with a cross-linking agent or a thermosetting resin added to it. Adding a cross-linking agent or a thermosetting resin so that the binder resin partly has a cross-linked structure helps improve the heat-resistant preservation properties, durability, and the like of the toner without degrading the fixing properties of the toner. When a thermosetting resin is used, the cross-linked fraction (gel fraction) of the binder resin extracted using a Soxhlet extractor is, with respect to the mass of the binder resin, preferably 10 mass % or less, and more preferably 0.1 mass % or more but 10 mass % or less.

As a thermosetting resin usable with a thermoplastic resin, an epoxy resin or a cyanate-based resin is preferred. Examples of suitable thermosetting resins include bisphenol A-type epoxy resins, hydrogenated bisphenol A-type epoxy resins, novolak-type epoxy resins, polyalkylene ether-type epoxy resins, cyclic aliphatic group-type epoxy resins, and cyanate resins. Two or more of these thermosetting resins can be used in combination.

The glass transition point (Tg) of the binder resin is preferably 40° C. or more but 70° C. or less. If the glass transition point is too high, the fixing properties of the toner at a low temperature tend to be poor. If the glass transition point is too low, the heat-resistant preservation properties of the toner tend to be poor.

The glass transition point of the binder resin can be determined from the changing point of the specific heat of the binder resin using a differential scanning calorimeter (DSC). More specifically, the glass transition point of the binder resin can be determined by plotting the endothermic curve of the binder resin using a differential scanning calorimeter (DSC-6200, manufactured by Seiko Instruments Inc.) as a measuring instrument. 10 mg of a measurement sample is put in an aluminum pan while an empty aluminum pan is used as a reference. From the endothermic curve of the binder resin plotted through measurement in a normal-temperature normal-humidity environment in the range of measurement temperature from 25° C. or more but 200° C. or less at a heating rate of 10° C. per minute, the glass transition point of the binder resin can be determined.

The mass average molecular weight (Mw) of the binder resin is not particularly limited within the scope consistent with the object of the present disclosure. Typically, the mass average molecular weight (Mw) of the binder resin is preferably 20,000 or more but 300,000 or less, and more preferably 30,000 or more but 200,000 or less. The mass average molecular weight of the binder resin can be determined by gel permeation chromatography (GPC) using a standard curve previously prepared using a standard polystyrene resin.

### (Release Agent)

For the purpose of improving its fixing properties and anti-offsetting properties, the toner core particle can contain a release agent. The type of release agent that can be added to the toner core particle is not limited within the scope consistent with the object of the present disclosure. As such a release agent, wax is preferred. Examples of wax include carnauba wax, synthetic ester wax, polyethylene wax, polypropylene wax, fluorocarbon resin-based wax, Fischer-Tropsch wax, paraffin wax, montan wax, and rice wax. Two or more of these release agents can be used in combination. Adding such a release agent to the toner core particle helps more effectively suppress offsetting and image smearing (stain around an image caused by its being rubbed).

When a polyester resin is used as the binder resin, from the viewpoint of compatibility, as a release agent, one or more release agents selected from the group consisting of carnauba wax, synthetic ester wax, and polyethylene wax is suitably used. On the other hand, when a polystyrene-based resin is used as the binder resin, likewise from the viewpoint of compatibility, as a release agent, Fischer-Tropsch wax and/or paraffine wax is suitably used.

Fischer-Tropsch wax is a straight-chain hydrocarbon compound with few iso-structure molecules or side-chains that is produced by exploiting the Fischer-Tropsch reaction, which is a catalytic hydrogenation reaction of carbon monoxide.

Preferred among different types of Fischer-Tropsch wax are those that have a mass average molecular weight of 1,000 or more of which the bottom temperature of the endothermic peak observed by DSC measurement falls within the range of 100° C. or more but 120° C. or less. Examples of such types of Fischer-Tropsch wax include the following products available from Sasol Ltd.: Sasol Wax C1 (endothermic peak bottom temperature: 106.5° C.), Sasol Wax C105 (endothermic peak bottom temperature: 102.1° C.), Sasol Wax Spray (endothermic peak bottom temperature: 102.1° C.), and the like.

The amount of release agent used is not particularly limited within the scope consistent with the object of the present disclosure. Specifically, the amount of release agent used is, relative to the total mass of the toner core particle, preferably 1 mass % or more but 10 mass % or less. Using too small an amount of release agent can result in less-than-expected suppression of offsetting or image smearing in image formation; using too large an amount of release agent can result in fusing-together of toner particles and hence poor heat-resistant preservation properties of toner.

### (Colorant)

The toner core particle contains a colorant. As the colorant that can be contained in the toner core particle, any known pigment or dye that suits the color of the toner can be used. Specific examples of colorants that can be suitably added to the toner include: black pigments such as carbon black, acetylene black, lamp black, aniline black; yellow pigments such as chrome yellow, zinc yellow, cadmium yellow, yellow iron oxide, mineral fast yellow, nickel titanium yellow, Naples yellow, naphthol yellow S, Hansa yellow G, Hansa yellow 10G, benzidine yellow G, benzidine yellow GR, quinoline yellow lake, permanent yellow NCG, tartrazine lake, monoazo yellow, and diazo yellow; orange pigments such as reddish chrome yellow, molybdenum orange, permanent orange GTR, pyrazolone orange, Vulcan Orange, and indanthrene brilliant orange GK; red pigments such as red iron oxide, cadmium red, red lead, mercury cadmium sulfide, permanent red 4R, lithol red, pyrazolone red, Watchung red calcium salt, lake red D, brilliant carmine 6B, eosine lake, rhodamine lake B, alizarin lake, brilliant carmine 3B, and monoazo red; violet pigments such as manganese violet, fast violet B, and methyl violet lake; blue pigments such as Prussian blue, cobalt blue, alkali blue lake, partially chlorinated Victoria blue, fast sky blue, indanthrene blue BC, and phthalocyanine blue; green pigments such as chrome green, chromium oxide, pigment green B, malachite green lake, and final yellow green G; white pigments such as zinc white, titanium oxide, antimony white, and zinc sulfide; and extender pigments such as barite powder, barium carbonate, clay, silica, white carbon, talc, and alumina white. Two or more of these colorants can be used in combination for the purpose of adjusting the toner to the desired hue and the like.

The amount of colorant used is not particularly limited within the scope consistent with the object of the present disclosure. Specifically, the amount of colorant used is, relative to the total mass of the toner core particle, preferably 1 mass % or more but 10 mass % or less, and more preferably 2 mass % or more but 7 mass % or less.

A colorant can be used as a master batch having a colorant previously dispersed in a resin material such as a thermoplastic resin. When a colorant is used as a master batch, the resin contained in the master batch is preferably a resin of the same type as the binder resin.

### (Charge Control Agent)

Preferably, the toner core particle contains a charge control agent for the purposes of improving the charge level of the toner and the charge response properties as the index of whether it can be charged to a predetermined charge level in a short time, and thereby obtaining toner with excellent durability and stability. Since the toner according to the present disclosure is positively chargeable, a positively chargeable charge control agent is used.

The type of charge control agent that can be contained in the toner core particle is not particularly limited within the scope consistent with the object of the present disclosure. Any of charge control agents known to be used in toner can be appropriately selected and used. Specific examples of positively chargeable charge control agents include: azine compounds such as pyridazine, pyrimidine, pyrazine, orthoxazine, metaoxazine, paraoxazine, orthothiazine, metathiazine, parathiazine, 1,2,3-triazine, 1,2,4-triazine, 1,3,5-triazine, 1,2,4-oxadiazine, 1,3,4-oxadiazine, 1,2,6-oxadiazine, 1,3,4-thiadiazine, 1,3,5-thiadiazine, 1,2,3,4-tetrazine, 1,2,4,5-tetrazine, 1,2,3,5-tetrazine, 1,2,4,6-oxatriazine, 1,3,4,5-oxatriazine, phthalazine, quinazoline, and quinoxaline; direct dyes composed of azine compounds, such as azine fast red FC, azine fast red 12BK, azine violet BO, azine brown 3G, azine light brown GR, azine dark green BH/C, azine deep black EW, and azine deep black 3RL; nigrosine compounds, such as nigrosine, nigrosine salts, and nigrosine derivatives; acid dyes composed of nigrosine compounds, such as nigrosine BK, nigrosine NB, and nigrosine Z; metal salts of naphthenic acid or higher fatty acids; alkoxylated amines; alkylamides; and quaternary ammonium salts, such as benzylmethylhexyldecylammonium and decyltrimethylammonium chloride. Among these positively chargeable charge control agents, nigrosine compounds are particularly preferred for their faster charge response properties. Two or more of these positively chargeable charge control agents can be used in combination.

Also usable as a positively chargeable charge control agent are resins that have as a functional group a quaternary ammonium salt, a carboxylic acid salt, or a carboxyl group. Specific examples include styrene-based resin having a quaternary ammonium salt, acrylic-based resin having a quaternary ammonium salt, styrene-acrylic-based resin having a quaternary ammonium salt, polyester resin having a quaternary ammonium salt, styrene-based resin having a carboxylic acid salt, acrylic-based resin having a carboxylic acid salt, styrene-acrylic-based resin having a carboxylic acid salt, polyester resin having a carboxylic acid salt, styrene-based resin having a carboxylic group, acrylic-based resin having a carboxylic group, styrene-acrylic-based resin having a carboxylic group, and polyester resin having a carboxylic group. The molecular weight of these resins is not particularly limited within the scope consistent with the object of the present disclosure, and they can be in the form of an oligomer or a polymer.

Among resins usable as a positively chargeable charge control agent, from the viewpoint of easy adjustment of the amount of charge within a desired range, styrene-acrylic-based resin having as a functional group a quaternary ammonium salt is more preferred. Specific examples of preferred acrylic-based comonomers for copolymerization with the styrene unit in styrene-acrylic-based resin having as a functional group a quaternary ammonium salt include esters of alkyl (meth)acrylates such as methyl acrylate, ethyl acrylate, n-propyl acrylate, iso-propyl acrylate, n-butyl acrylate, iso-butyl acrylate, 2-ethylhexyl acrylate, methyl methacrylate, ethyl methacrylate, n-butyl methacrylate, and iso-butyl methacrylate.

Used as a quaternary ammonium salt is a unit derived by a quaternization process from a dialkyl aminoalkyl (meth)acrylate, dialkyl (meth)acryl amide, or dialkyl aminoalkyl (meth)acryl amide. Specific examples of dialkyl aminoalkyl (meth)acrylate include dimethylaminoethyl (meth)acrylate, diethyl aminoethyl (meth)acrylate, dipropyl aminoethyl (meth)acrylate, and dibutyl aminoethyl (meth)acrylate. Specific examples of dialkyl (meth)acrylamide include dimethyl methacryl amide. Specific examples of dialkyl aminoalkyl (meth)acrylamide include dimethyl aminopropyl methacrylamide. In polymerization, a polymerizable monomer containing the hydroxy group such as hydroxyethyl (meth)acrylate, hydroxypropyl (meth)acrylate, 2-hydroxybutyl (meth)acrylate, or N-methylol (meth)acrylamide can be used together.

The amount of charge control agent used is not particularly limited within the scope consistent with the object of the present disclosure. Typically, the amount of charge control agent used is, relative to the total mass of the toner core particle, preferably 0.1 mass % or more but 10 mass % or less. Using too small an amount of charge control agent makes it difficult to stably charge the toner with a predetermined polarity. This can lead to a lower-than-expected value in the image density of the formed image and make it difficult to maintain satisfactory image density for a long period. Also, the charge control agent is then difficult to disperse evenly, and this tends to cause fogging in the formed image and contamination of a latent image carrying member with toner components. Using too large an amount of charge control agent can lead to poorer resistance to environment and this tends to cause image faults in the formed image due to insufficient charging under high temperature and high humidity, contamination of a latent image carrying member with toner components, and the like.

### (Magnetic Powder)

The toner core particle can contain a magnetic powder. Suitably usable as the material of the magnetic powder is, for example, a ferromagnetic metal (more specifically, iron, cobalt, nickel, an alloy containing one or more of these metals, or the like), a ferromagnetic metal oxide (more specifically, ferrite, magnetite, chromium dioxide, or the like), or a material subjected to ferromagnetization (more specifically, a carbon material made ferromagnetic by heat treatment, or the like). To suppress the elution of a metal ion (e.g., iron ion) from the magnetic powder, it is preferable to use surface-treated magnetic particles as the magnetic powder. One type of magnetic powder can be used singly or a plurality of types of magnetic powder can be used in combination.

### (Shell Material)

The toner core particle can have, if so desired, its surface coated by a shell layer. If the toner core particle has a shell layer formed on it, the shell layer is formed of resin fine particles. To give the shell layer an adequate level of surface absorption, it is particularly preferable that the shell layer include a resin film composed mainly of an agglomeration of resin particles with a glass transition point of 50° C. or more but 100° C. or less; that heat-resistant particles forming the resin film have a number average circularity of 0.55 or more but 0.75 or less; that the heat-resistant particles contain a resin having one or more types of repeating unit derived from a styrene-based monomer, a repeating unit having an alcoholic hydroxyl group, and a repeating unit derived from a nitrogen-containing vinyl compound; and that the repeating unit with the highest mass proportion among the repeating units in the resin contained in the heat-resistant particle is a repeating unit derived from a styrene-based monomer.

With regard to the shell layer described above (i.e., the resin film composed mainly of an agglomeration of heat-resistant particles), to give the toner satisfactory heat-resistant preservation properties, fixing properties, and charging properties, preferably, the shell layer has a thickness of 10 nm or more but 35 nm or less. The thickness of the shell layer can be measured, by using a commercially available image analysis software (e.g., “WinROOF;” developed by MITANI CORPORATION), analyzing a TEM (transmission electron microscopy) image of a section of the toner particle. If, in one toner particle, the shell layer has an uneven thickness, this can be coped with by measuring the thickness of the shell layer at four points evenly apart from each other (specifically, four points at which two straight lines drawn to orthogonally intersect substantially at the center of a section of the toner particle cross the shell layer) and taking the arithmetic average of the obtained four measurement values as the evaluation value (the thickness of the shell layer) of that toner particle. The boundary between the toner core particle and the shell layer can be recognized, for example, by selectively staining only the shell layer of the toner core particle and the shell layer. If, in the TEM image, the boundary between the toner core particle and the shell layer is obscure, TEM and electron energy loss spectroscopy (EELS) can be used in combination to map elements characteristic of the shell layer. This clarifies the boundary between the toner core particle and the shell layer.

With regard to the shell layer described above (i.e., the resin film composed mainly of an agglomeration of heat-resistant particles), to give the toner satisfactory heat-resistant preservation properties, fixing properties, and charging properties, preferably, the shell layer covers 50% or more but 80% or less of the area of the surface region of the toner core particle. The proportion in area of the region covered by the shell layer out of the surface region of the toner core particle can be determined by obtaining an image of the surface of the toner particle (e.g., a previously stained toner particle) using an electron microscope and analyzing the obtained image using commercially available image analysis software.

### (External Additive)

In the toner according to the present disclosure, the toner base particle is treated with an external additive. The external additive used in the toner according to the present disclosure at least contains first and second resin fine particles.

### (Resin Fine Particles)

The materials of the first and second resin fine particles are not particularly limited so long as their SP values can each be adjusted within the ranges previously described. The resin fine particles are surface-treated with a surfactant. Surface-treating the resin fine particles with a surfactant helps suppress agglomeration of the resin fine particles.

While, as a surfactant, any of cationic surfactants, anionic surfactants, and nonionic surfactants can be used, if the resin fine particles are surface-treated with an anionic surfactant or a nonionic surfactant, when the resin fine particles are externally added to the toner base particle, the positive chargeability of the toner is slightly reduced. Thus, it is preferable to use a cationic surfactant.

Examples of cationic surfactants include cetyl trimethyl ammonium chloride. Examples of anionic surfactants include dodecyl benzene sulfonate. Examples of nonionic surfactants include polyvinyl alcohol.

Note that the first and second resin fine particles can be subjected to any other surface treatment. Examples of other surface treatment include hydrophobization treatment, positive charging treatment, and conductive treatment.

If the toner base particle contains a polyester resin as a binder resin and in addition a resin constituting the first and second resin fine particles is a cross-linked resin, then, for easy adjustment of the SP value within the range previously described, preferably, the cross-linked resin is a polymer of a styrene-based monomer, an acrylic acid-based monomer, and a cross-linking agent having two or more unsaturated bonds (hereinafter such a polymer is often referred to as the specific cross-linked polymer).

Examples of styrene-based monomers for synthesis of the specific cross-linked polymer include styrene, o-methylstyrene, m-methylstyrene, p-methylstyrene, p-phenylstyrene, p-ethylstyrene, 2,4-dimethylstyrene, p-t-butylstyrene, p-n-hexylstyrene, p-n-octylstyrene, p-n-nonylstyrene, p-n-decylstyrene, and p-n-dodecylstyrene.

Examples of acrylic acid-based monomers for synthesis of the specific cross-linked polymer include (meth)acrylic acid, methyl (meth)acrylate, ethyl (meth)acrylate, n-propyl (meth)acrylate, isopropyl (meth)acrylate, n-butyl (meth)acrylate, isobutyl (meth)acrylate, t-butyl (meth)acrylate, n-octyl (meth)acrylate, 2-ethylhexyl (meth)acrylate, stearyl (meth)acrylate, lauryl (meth)acrylate, and phenyl (meth)acrylate.

Examples of cross-linking agent having two or more unsaturated bonds for synthesis of the specific cross-linked polymer include N,N′-methylene bisacrylamide, divinylbenzene, ethylene glycol diacrylate, ethylene glycol dimethacrylate, diethylene glycol diacrylate, tetraethylene glycol diacrylate, polyethylene glycol diacrylate, 1,4-butanediol diacrylate, 1,6-hexanediol diacrylate, tripropylene glycol diacrylate, trimethylol propane triacrylate, pentaerythritol triacrylate, pentaerythritol tetraacrylate, 1,4-butanediol dimethacrylate, and 1,6-hexanediol dimethacrylate.

To obtain toner that excels more in charging stability and heat-resistant preservation properties, preferably, the cross-linking agent having two or more unsaturated bonds is ethylene glycol dimethacrylate.

To obtain toner that excels even more in charging stability and heat-resistant preservation properties, preferably, the binder resin in the toner base particle is a polyester resin and the resin constituting the first and second resin fine particles is a polymer (cross-linked polymer) of styrene, methyl methacrylate, and ethylene glycol dimethacrylate.

The method for forming the first and second resin fine particles is not particularly limited. Examples of the method for forming the first and second resin fine particles include emulsion polymerization, seed polymerization, and dispersion polymerization. In the embodiment, a commercially available product can be used as the first and second resin fine particles.

In combination with the first and second resin fine particles described above, another external additive can be used. The type of external additive that can be used together with the first and second resin fine particles is not particularly limited within the scope consistent with the object of the present disclosure and thus can be selected appropriately from external additives known to be used in toner, such as inorganic particles. Two or more of these external additives can be used in combination.

### [Production Method for Toner]

Next, a production method for the toner according to the present disclosure will be described. The production method for the toner includes a production method for a toner core particle and an external additive treatment method for attaching an external additive to the surface of the toner base particle. The production method for the toner core particle is not particularly limited so long as it forms the toner core particle with a predetermined structure. As necessary, a toner core particle coated with a shell layer can be used as the toner base particle. As a suitable production method for the positively chargeable toner described above, a method for producing the toner core particle, a method for forming the shell layer, and the method for external addition treatment will be described one by one below.

### (Method for Producing Toner Core Particle)

The method for producing the toner core particle is not particularly limited so long as it can satisfactorily disperse any optional components such as a colorant, a release agent, a charge control agent, and a magnetic powder in the binder resin. Examples of suitable methods for producing the toner core particle include a pulverization method and an agglomeration method.

In the pulverization method, the binder resin and any components such as a colorant, a release agent, a charge control agent, and a magnetic powder are mixed using a mixer and the like; then the binder resin and the components blended in the binder resin are melted and kneaded using a kneader such as a uniaxial or biaxial extruder; and the cooled kneaded product is pulverized and classified. While the average particle size of the toner core particle is not particularly limited within the scope consistent with the object of the present disclosure, generally it is preferably 5 μm or more but 10 μm or less.

In the agglomeration method, in an aqueous medium containing fine particles of each of the binder resin, a release agent, a charge control agent, and a colorant, these fine particles are agglomerated until they have a predetermined particle size. This forms an agglomerate particle containing the binder resin, the release agent, the charge control agent, and the colorant. Subsequently, the obtained agglomerate particle is heated so that the components in the agglomerate particle coalesce. This yields a toner core particle with a predetermined particle size.

### (Method for Forming Shell Layer)

To coat the surface of the toner core particle with the shell layer, resin fine particles are attached to the surface of the toner core particle to form the shell layer.

The method will be described more specifically. First, in a mixing apparatus, hydrochloric acid is added to ion-exchange water to prepare an aqueous medium with weak acidity (e.g., with a pH value selected from the range of three or more but five or less). Subsequently, to the aqueous medium with the so adjusted pH value, a dispersion liquid (suspension) of resin fine particles as a shell material and the toner core particle are added.

Subsequently, while the mixture liquid containing the shell material and the toner core particle is stirred, the temperature of the mixture liquid is raised up to a predetermined holding temperature (e.g., a temperature selected from the range of 50° C. or more but 90° C. or less) at a predetermined rate (e.g., a rate selected from the range of 0.1° C./min or more but 3° C./min or less). Then, the mixture liquid is, while being stirred, held at the predetermined holding temperature for a predetermined time (e.g., a length of time selected from the range of 30 minutes or more but 4 hours or less). It is considered that, while the temperature of the mixture liquid is held high, a reaction (fixation of the shell layer) proceeds between the toner core particle and the shell material. The shell material binds to the toner core particle to form the shell layer. The formation of the shell layer on the surface of the toner core particle in the mixture liquid yields a dispersion liquid of toner base particles.

### (Method for External Addition Treatment)

The method for treatment of the toner base particle with the external additive is not particularly limited; the toner base particle can be treated by any known method. Specifically, the toner base particle is treated with the external additive using a mixer such as a Henschel mixer or a Nauta mixer under treatment conditions adjusted such that the particles of the external additive do not sink in the toner base particle.

The toner according to the present disclosure described above excels in fixing properties and heat-resistant preservation properties. In cases where images are formed for a long period in various environments including a high-temperature high-humidity environment and low-temperature low-humidity environment, the toner can be electrostatically charged to a desired charge amount. Thus, the images can be formed with the desired density. Accordingly, the toner for use in development of an electrostatic latent image according to the present disclosure can be suitably used in a variety of image forming apparatuses. Now, the effects of the present disclosure will be described more specifically by way of examples. The present disclosure is not limited in any way by those examples.

### EXAMPLES

### Production Example 1

### (Production of Toner Base Particle)

82 mass % of a polyester resin (HP-313, manufactured by The Nippon Synthetic Chemical Industry Co., Ltd.) as a binder resin, 6.0 mass % of carbon black (MA-100, manufactured by Mitsubishi Chemical Corporation) as a colorant, 2.0 mass % of a charge control agent (N-01, manufactured by ORIENT CHEMICAL INDUSTRIES CO., LTD.), 4.0 mass % of a charge control agent (FCA-201-PS, manufactured by Fujikura Kasei Co., Ltd.), and 6.0 mass % of ester wax (WEP-3, manufactured by NOF CORPORATION) as a release agent were mixed using a Henschel mixer (FM-10 model, manufactured by Mitsui Mining & Smelting) to obtain a mixture. The obtained mixture was then melted and kneaded using a biaxial extruder (TEM-26SS, manufactured by Toshiba Machine Co., Ltd.) to obtain a kneaded product. The kneaded product was coarsely pulverized down to around 2 mm using a Rotoplex pulverizer (manufactured by Toa Machine Industry). The obtained coarsely pulverized product was then finely pulverized using a mechanical pulverizer (Turbomill RS model, manufactured by Turbo Industries) to obtain a finely pulverized product. The finely pulverized product was classified using a wind-power classifier (EJ-L-3 (LABO) model, manufactured by NITTETSU MINING) to obtain toner base particles with a volume average particle size (D50) of 7.0 μm. The volume average particle size was measured using a Coulter Counter Multisizer 3 (manufactured by Beckman Coulter, Inc.).

### Production Example 2

### (Production of Resin Fine Particles)

25 mass parts of styrene, 41 mass parts of methyl methacrylate, 34 mass parts of ethylene glycol dimethacrylate, 4.5 mass parts of potassium peroxide (water-soluble polymerization initiator), 100 mass parts of ion exchange water, and 4.0 mass parts of a cationic surfactant (cetyl trimethyl ammonium chloride) were loaded in a round bottom flask and were stirred with an anchor-shaped stirring blade at 100 rpm. The mixture was subjected to emulsion polymerization by soap-free polymerization at 75° C. for eight hours to obtain a dispersion liquid of resin fine particles.

The obtained dispersion liquid was filtered and then the solid components were washed with water and dried to produce resin fine particles RA-1. The particle diameter was adjusted by controlling the nozzle aperture diameter and the spraying rate. Resin fine particles RA-1 had a number average primary particle size of 80 nm as measured on a scanning electron microscope (JSM-7600F, manufactured by JEOL LTD.).

Resin fine particles RA-2 to RA-15 and RB-1 to RB-13 were obtained through a procedure similar to that for resin fine particles RA-1 except for the use of different types and blended amounts of monomers, different stirring rates and different polymerization periods.

### [Measurement of Hardness and Degree of Hydrophobization of Resin Fine Particles]

Of resin fine particles RA-1 to RA-15 and RB-1 to RB-13 obtained in production example 2, the hardness and the degree of hydrophobization were measured by the methods described below.

### (Measurement of Hardness of Resin Fine Particles)

As a measuring device, AFM5000II (manufactured by Hitachi High-Tech Science Corporation) was used. As a cantilever, “SI-DF40 with an Al-coated back” (manufactured by Hitachi High-Tech Science Corporation) was used. The cantilever just mentioned had a tip radius R of 10 nm, a probe height D of 12.5 μm, a lever length L of 125 μm, a lever width W of 30 μm, a lever thickness T of 4 μm, and a spring constant of 42 N/m. The AFM surface hardness of the superficial surface of the resin fine particle was measured to obtain a force curve. Note that a measurement sample was prepared as a pellet of resin fine particles with a diameter of 20 mm to ensure a stable sample base. The measurement conditions were as follows: temperature in the measurement room: 23.5° C., humidity in the measurement room: 50% RH, measurement atmosphere: air, measurement region: 6 μm×6 μm, torsion spring constant: 1 N/m, resonance frequency: 150 Hz. The stress was measured at 30 points with a probe displacement of 40 nm and the measurements were averaged.

### (Measurement of Degree of Hydrophobization of Resin Fine Particles)

The degree of hydrophobization was determined by the methanol wettability method (the MW method), through the following procedure. In advance, mixed solutions of methanol and water were prepared with predetermined concentrations of methanol (in steps of 1 vol %). 50 mL of each of the methanol solutions with different concentrations were put in a beaker with a volume of 100 mL and 0.2 g of the sample powder (resin fine particles) were added. The mixture liquid was stirred with a magnetic stirrer. Based on the concentrations of the methanol solutions in which the whole amount of the sample powder settled out and those in which it did not, the methanol wettability values were determined.

Tables 1 and 2 show the SP value, the hardness, the degree of hydrophobization, and the number average primary particle size of resin fine particles RA-1 to RA-15 and RB-1 to RB-13, along with the blended amounts (mass parts) of the monomers and the surfactant used in the production of resin fine particles RA-1 to RA-15 (the first resin fine particles) and RB-1 to RB-13 (the second resin fine particles).

TABLE 1

| | | | | | Polymerization Conditions | | Physical Properties | | | |
|---|---|---|---|---|---|---|---|---|---|---|
| 1st Resin | Material [mass parts] | | | | Stirring | Polymerization | | | Hydrophobization | Particle |
| Fine | | | | Cationic | Rate | Period | SP | Hardness | Degree | Size |
| Particles | Styrene | MMA | EGDM | Surfactant | [rpm] | [hr] | value | [μN] | [%] | [nm] |
| RA-1 | 25.0 | 41.0 | 34.0 | 4.0 | 150 | 8 | 9.61 | 1.2 | 10 | 80 |
| RA-2 | 33.3 | 32.7 | 34.0 | 5.4 | 150 | 10 | 9.42 | 1.2 | 10 | 80 |
| RA-3 | 17.2 | 46.8 | 36.0 | 2.8 | 150 | 6 | 9.80 | 1.3 | 10 | 80 |
| RA-4 | 34.0 | 32.0 | 34.0 | 5.4 | 150 | 10 | 9.40 | 1.2 | 10 | 80 |
| RA-5 | 16.0 | 48.0 | 36.0 | 2.7 | 150 | 6 | 9.83 | 1.3 | 10 | 80 |
| RA-6 | 25.0 | 41.0 | 34.0 | 5.1 | 150 | 9.5 | 9.61 | 1.2 | 5 | 80 |
| RA-7 | 25.0 | 41.0 | 34.0 | 2.9 | 150 | 6.5 | 9.61 | 1.2 | 16 | 80 |
| RA-8 | 25.0 | 41.0 | 34.0 | 5.3 | 150 | 10 | 9.61 | 1.2 | 4 | 80 |
| RA-9 | 25.0 | 41.0 | 34.0 | 2.6 | 150 | 6 | 9.61 | 1.2 | 17 | 80 |
| RA-10 | 25.0 | 46.0 | 29.0 | 4.0 | 150 | 8 | 9.59 | 1.0 | 11 | 80 |
| RA-11 | 25.0 | 49.0 | 26.0 | 5.4 | 150 | 10 | 9.58 | 0.9 | 11 | 80 |
| RA-12 | 25.0 | 41.0 | 34.0 | 4.0 | 200 | 8 | 9.42 | 1.2 | 10 | 60 |
| RA-13 | 25.0 | 41.0 | 34.0 | 4.0 | 100 | 8 | 9.42 | 1.2 | 10 | 100 |
| RA-14 | 25.0 | 41.0 | 34.0 | 4.0 | 212 | 8 | 9.42 | 1.2 | 10 | 55 |
| RA-15 | 25.0 | 41.0 | 34.0 | 4.0 | 88 | 8 | 9.42 | 1.2 | 10 | 105 |

TABLE 2

| | | | | | Polymerization Conditions | | Physical Properties | | | |
|---|---|---|---|---|---|---|---|---|---|---|
| 2nd Resin | Material [mass parts] | | | | Stirring | Polymerization | | | Hydrophobization | Particle |
| Fine | | | | Cationic | Rate | Period | SP | Hardness | Degree | Size |
| Particles | Styrene | MMA | EGDM | Surfactant | [rpm] | [hr] | value | [μN] | [%] | [nm] |
| RB-1 | 41.0 | 25.0 | 34.0 | 2.4 | 250 | 5.5 | 9.24 | 1.2 | 30 | 40 |
| RB-2 | 64.0 | 5.0 | 31.0 | 6.0 | 250 | 11 | 8.70 | 1.1 | 30 | 40 |
| RB-3 | 34.0 | 32.0 | 34.0 | 1.4 | 250 | 10 | 9.40 | 1.2 | 30 | 40 |
| RB-4 | 67.0 | 2.0 | 31.0 | 6.2 | 250 | 10.5 | 8.65 | 1.1 | 30 | 40 |
| RB-5 | 33.3 | 32.7 | 34.0 | 1.4 | 250 | 10 | 9.42 | 1.2 | 30 | 40 |
| RB-6 | 41.0 | 25.0 | 34.0 | 4.8 | 250 | 8.5 | 9.24 | 1.2 | 18 | 40 |
| RB-7 | 41.0 | 25.0 | 34.0 | 5.0 | 250 | 9 | 9.24 | 1.2 | 17 | 40 |
| RB-8 | 41.0 | 30.0 | 29.0 | 2.6 | 250 | 6 | 9.22 | 1.0 | 30 | 40 |
| RB-9 | 41.0 | 33.0 | 26.0 | 5.4 | 250 | 10 | 9.21 | 0.9 | 30 | 40 |
| RB-10 | 41.0 | 25.0 | 34.0 | 2.4 | 275 | 5.5 | 9.24 | 1.2 | 30 | 30 |
| RB-11 | 41.0 | 25.0 | 34.0 | 2.4 | 225 | 5.5 | 9.24 | 1.2 | 30 | 50 |
| RB-12 | 41.0 | 25.0 | 34.0 | 2.4 | 287.5 | 5.5 | 9.24 | 1.2 | 30 | 25 |
| RB-13 | 41.0 | 25.0 | 34.0 | 2.4 | 212.5 | 5.5 | 9.24 | 1.2 | 30 | 55 |

MMA: methyl methacrylate
EGDM: ethylene glycol dimethacrylate

### Production Example 3

### (External Addition Treatment of Toner Base Particle)

For 100 mass parts of the toner base particles obtained in production example 1, 1.5 mass parts of positively chargeable silica particles (CAB-O-SIL TG-308F, manufactured by Cabot Corporation.) and 1.0 mass part of titanium oxide (MT-500B, manufactured by Tayca Corporation) were mixed for five minutes at a rotation rate of 3500 rpm using a Henschel mixer (FM-10 model, manufactured by Mitsui Mining & Smelting). Then, a predetermined mass part of resin fine particles, each of RA-1 to RA-15 and RB-1 to RB-13 obtained in production example 2, were added and mixed for five minutes at a rotation rate of 3500 rpm so that the resin fine particles were externally added. The coverage ratio with the resin fine particles with respect to the surface of the toner base particle was adjusted to 30%. In this way, toners of Practical Examples 1 to 17 of the present disclosure and of Comparative Examples 1 to 19 were produced in which different kinds of resin fine particles were externally added.

### Production Example 4

### (Production of Carrier)

In 20 L of acetone, 2 kg of an epoxy resin (Epikote 1004, manufactured by Japan Epoxy Resins Co., Ltd.) were dissolved, and to this solution 100 g of diethylenetriamine and 150 g of phthalic anhydride were added and mixed to produce a coating liquid.

Using a fluidized bed-coating machine (SFC-5, manufactured by Freund Corporation), 10 kg of carrier cores (F51-50, manufactured by Powdertech Co., Ltd., with a particle size of 50 μm) kept in a fluid state were sprayed with the coating liquid while a hot wind at 80° C. is blown into them to obtain carrier cores coated with the coating liquid. The carrier cores coated with the coating liquid were baked for one hour at 180° C. using an electric furnace to obtain carrier particles.

### Production Example 5

### (Production of Two-Component Developer)

The carrier particles obtained in production example 4 and each of toners of Practical Examples 1 to 17 and Comparative Examples 1 to 19 obtained in production example 3 were mixed for 30 minutes using a rocking mixer (RM-10, manufactured by AICHI ELECTRIC CO., LTD.) so as to contain 8 mass % of the toner with respect to the carrier to prepare two-component developer.

### [Evaluation of Toner Charge Amount, Toner Scattering, and Drum Cleaning Properties]

With each of toners of Practical Examples 1 to 17 and Comparative Examples 1 to 19, its toner scattering, toner charge amount, and drum cleaning properties were evaluated by the methods described below.

### (Toner Scattering)

The evaluation developer obtained in production example 6 was loaded in a development unit in an evaluation machine (TASKalfa 7054ci, manufactured by KYOCERA Document Solutions Inc.). On the other hand, toner corresponding to the developer loaded in the development unit was loaded in a toner container in the evaluation machine. In a normal-temperature normal-humidity environment (temperature: 23° C., humidity: 50% RH), a test image with a printing rate of 5% was printed continuously on 10,000 A4-sized sheets of plain paper. After cleaning the top lid of the development unit and the inside of the evaluation machine, the evaluation machine was left to stand for 24 hours in an ultra-low humidity environment (an NLL environment, 23° C., 5% RH) and a test image with a printing rate of 5% was printed on 100 sheets before toner scattering was visually checked. Similarly, in a high-temperature high-humidity environment (an HH environment, 32.5%, 80% RH) only during initial printing, toner scattering was evaluated. The evaluation criteria for toner scattering were as follows:
Excellent: No toner scattering observed (practically satisfactory).
Good: Toner scattering observed on the top lid near a sleeve of the development unit (practically satisfactory).
Fair: Toner scattering observed across the entire top lid of the development unit (practically unsatisfactory).
Poor: Toner scattering observed most parts inside the evaluation machine (practically unsatisfactory).

### (Toner Charge Amount)

In an ultra-low humidity environment (an NLL environment, 23° C., 5% RH), using the initial toner and the evaluation machine (TASKalfa 7054ci, manufactured by KYOCERA Document Solutions Inc.), a test image with a printing rate of 5% was printed on 10,000 sheets and then (i.e., after durability printing) the rise of toner charge amount was measured. In a plastic container with a volume of 20 cc, 0.8 g of the toner and 10 g of the carrier were put and mixed for three minutes using a Turbula Shaker-Mixer (T2F, manufactured by Shinmaru Enterprises Corporation) and the charge amount was measured. The charge amount was measured of the toner sucked through a sieve (made of stainless steel, a twill weave, a wire diameter of 0.0027 mm) with a sieve opening of 38 μm using a suction type small-sized charge amount measurement device (manufactured by TRek Inc.). Similarly, also in a high-temperature high-humidity environment (an HH environment, 32.5° C., 80% RH), the toner charge amount was measured. The evaluation criteria were as follows:
A charge amount of 16 μC/g or more (practically satisfactory).
A charge amount of 10 μC/g to 15 μC/g or less (practically satisfactory).
A charge amount of 5 μC/g to 9 μC/g or less (practically unsatisfactory).
A charge amount less than 5 μC/g (practically unsatisfactory).

### (Drum Cleaning Properties)

In a normal-temperature normal-humidity environment (an NN environment, 23° C., 50% RH), using the evaluation machine (TASKalfa 7054ci, manufactured by KYOCERA Document Solutions Inc.), a test image with a printing rate of 5% was printed on 10,000 sheets, and then a half-tone image was printed. The obtained half-tone image was checked visually for an image defect in the form of stripes. In addition, after the printing of the half-tone image, the surface of a charging device was visually checked for a toner component attached to it. The evaluation criteria for cleaning properties were as follows:
Good: No image defect in the form of stripes in the half-tone image and no toner component attached to the surface of the charging device (practically satisfactory).
Fair: No image defect in the form of stripes in the half-tone image but a little toner components attached to the surface of the charging device (practically satisfactory).
Poor: An image defect in the form of stripes in the half-tone image and many toner components attached to the surface of the charging device (practically unsatisfactory).

Tables 3 and 4 show the results of evaluation of toner charge amount, toner scattering, and drum cleaning properties with each of toners of Practical Examples 1 to 17 and Comparative Examples 1 to 19.

TABLE 3

| | | | | | Ultra-low Humidity Environment (23° C., 5% RH) | |
|---|---|---|---|---|---|---|
| | | | | | Toner Charge Amount | |
| | 1st Resin Fine Particles | | 2nd Resin Fine Particles | | [μC/g] | |
| | | Coverage | | Coverage | | After |
| | | Ratio | | Ratio | | Durability |
| Developer | Type | [%] | Type | [%] | Initial | Printing |
| Practical | RA-1 | 18 | RB-1 | 12 | 20 | 16 |
| Example 1 | | | | | | |
| Practical | RA-1 | 5 | RB-1 | 12 | 15 | 12 |
| Example 2 | | | | | | |
| Practical | RA-1 | 18 | RB-1 | 5 | 20 | 11 |
| Example 3 | | | | | | |
| Practical | RA-1 | 18 | RB-1 | 25 | 20 | 18 |
| Example 4 | | | | | | |
| Practical | RA-2 | 18 | RB-1 | 12 | 14 | 10 |
| Example 5 | | | | | | |
| Practical | RA-3 | 18 | RB-1 | 12 | 22 | 11 |
| Example 6 | | | | | | |
| Practical | RA-1 | 18 | RB-2 | 12 | 19 | 11 |
| Example 7 | | | | | | |
| Practical | RA-1 | 18 | RB-3 | 12 | 18 | 10 |
| Example 8 | | | | | | |
| Practical | RA-6 | 18 | RB-1 | 12 | 26 | 22 |
| Example 9 | | | | | | |
| Practical | RA-7 | 18 | RB-1 | 12 | 14 | 10 |
| Example 10 | | | | | | |
| Practical | RA-1 | 18 | RB-6 | 12 | 20 | 14 |
| Example 11 | | | | | | |
| Practical | RA-10 | 18 | RB-1 | 12 | 21 | 16 |
| Example 12 | | | | | | |
| Practical | RA-1 | 18 | RB-8 | 12 | 20 | 15 |
| Example 13 | | | | | | |
| Practical | RA-12 | 18 | RB-1 | 12 | 14 | 10 |
| Example 14 | | | | | | |
| Practical | RA-13 | 18 | RB-1 | 12 | 13 | 11 |
| Example 15 | | | | | | |
| Practical | RA-1 | 18 | RB-12 | 12 | 18 | 10 |
| Example 16 | | | | | | |
| Practical | RA-1 | 18 | RB-13 | 12 | 17 | 11 |
| Example 17 | | | | | | |

| | | | High-Temperature High- | | |
|---|---|---|---|---|---|
| | | | Humidity Environment | | |
| | Ultra-low Humidity Environment (23° C., 5% RH) | | (32.5° C., 80% RH) | | |
| | Toner Scattering | | Toner Charge | | |
| | | After | Amount | Toner | |
| | | Durability | [μC/g] | Scattering | Cleaning |
| Developer | Initial | Printing | Initial | Initial | Properties |
| Practical | Excellent | Excellent | 23 | Excellent | Good |
| Example 1 | | | | | |
| Practical | Good | Good | 17 | Excellent | Good |
| Example 2 | | | | | |
| Practical | Excellent | Good | 22 | Excellent | Good |
| Example 3 | | | | | |
| Practical | Excellent | Excellent | 22 | Excellent | Good |
| Example 4 | | | | | |
| Practical | Good | Good | 16 | Excellent | Good |
| Example 5 | | | | | |
| Practical | Excellent | Good | 24 | Excellent | Good |
| Example 6 | | | | | |
| Practical | Excellent | Good | 21 | Excellent | Good |
| Example 7 | | | | | |
| Practical | Excellent | Good | 21 | Excellent | Good |
| Example 8 | | | | | |
| Practical | Excellent | Excellent | 11 | Good | Good |
| Example 9 | | | | | |
| Practical | Good | Good | 29 | Excellent | Good |
| Example 10 | | | | | |
| Practical | Excellent | Good | 11 | Good | Good |
| Example 11 | | | | | |
| Practical | Excellent | Excellent | 22 | Excellent | Good |
| Example 12 | | | | | |
| Practical | Excellent | Good | 22 | Excellent | Good |
| Example 13 | | | | | |
| Practical | Good | Good | 16 | Excellent | Good |
| Example 14 | | | | | |
| Practical | Good | Good | 16 | Excellent | Good |
| Example 15 | | | | | |
| Practical | Excellent | Good | 20 | Excellent | Good |
| Example 16 | | | | | |
| Practical | Excellent | Good | 19 | Excellent | Good |
| Example 17 | | | | | |

TABLE 4

| | | | | | Ultra-low Humidity Environment (23° C., 5% RH) | |
|---|---|---|---|---|---|---|
| | | | | | Toner Charge Amount | |
| | 1st Resin Fine Particles | | 2nd Resin Fine Particles | | [μC/g] | |
| | | Coverage | | Coverage | | After |
| | | Ratio | | Ratio | | Durability |
| Developer | Type | [%] | Type | [%] | Initial | Printing |
| Comparative | RA-1 | 0 | RB-1 | 0 | 5 | 3 |
| Example 1 | | | | | | |
| Comparative | RA-1 | 18 | RB-1 | 0 | 20 | 6 |
| Example 2 | | | | | | |
| Comparative | RA-1 | 0 | RB-1 | 12 | 8 | 7 |
| Example 3 | | | | | | |
| Comparative | RA-1 | 4 | RB-1 | 12 | 13 | 9 |
| Example 4 | | | | | | |
| Comparative | RA-1 | 18 | RB-1 | 4 | 21 | 9 |
| Example 5 | | | | | | |
| Comparative | RA-1 | 18 | RB-1 | 26 | 20 | 19 |
| Example 6 | | | | | | |
| Comparative | RA-4 | 18 | RB-1 | 12 | 13 | 9 |
| Example 7 | | | | | | |
| Comparative | RA-5 | 18 | RB-1 | 12 | 24 | 9 |
| Example 8 | | | | | | |
| Comparative | RA-1 | 18 | RB-4 | 12 | 18 | 9 |
| Example 9 | | | | | | |
| Comparative | RA-1 | 18 | RB-5 | 12 | 17 | 8 |
| Example 10 | | | | | | |
| Comparative | RA-8 | 18 | RB-1 | 12 | 28 | 24 |
| Example 11 | | | | | | |
| Comparative | RA-9 | 18 | RB-1 | 12 | 12 | 8 |
| Example 12 | | | | | | |
| Comparative | RA-1 | 18 | RB-7 | 12 | 21 | 16 |
| Example 13 | | | | | | |
| Comparative | RA-11 | 18 | RB-1 | 12 | 20 | 16 |
| Example 14 | | | | | | |
| Comparative | RA-1 | 18 | RB-9 | 12 | 20 | 14 |
| Example 15 | | | | | | |
| Comparative | RA-14 | 18 | RB-1 | 12 | 12 | 7 |
| Example 16 | | | | | | |
| Comparative | RA-15 | 18 | RB-1 | 12 | 10 | 7 |
| Example 17 | | | | | | |
| Comparative | RA-1 | 18 | RB-12 | 12 | 19 | 9 |
| Example 18 | | | | | | |
| Comparative | RA-1 | 18 | RB-13 | 12 | 18 | 12 |
| Example 19 | | | | | | |

| | | | High-Temperature High-Humidity | | |
|---|---|---|---|---|---|
| | Ultra-low Humidity Environment (23° C., 5% RH) | | Environment (32.5° C., 80% RH) | | |
| | Toner Scattering | | Toner Charge | | |
| | | After | Amount | Toner | |
| | | Durability | [μC/g] | Scattering | Cleaning |
| Developer | Initial | Printing | Initial | Initial | Properties |
| Comparative | Fair | Poor | 15 | Good | Good |
| Example 1 | | | | | |
| Comparative | Excellent | Fair | 22 | Excellent | Good |
| Example 2 | | | | | |
| Comparative | Fair | Fair | 18 | Excellent | Good |
| Example 3 | | | | | |
| Comparative | Good | Fair | 15 | Good | Good |
| Example 4 | | | | | |
| Comparative | Excellent | Fair | 24 | Excellent | Good |
| Example 5 | | | | | |
| Comparative | Excellent | Excellent | 22 | Excellent | Poor |
| Example 6 | | | | | |
| Comparative | Good | Fair | 15 | Good | Poor |
| Example 7 | | | | | |
| Comparative | Excellent | Poor | 25 | Excellent | Good |
| Example 8 | | | | | |
| Comparative | Excellent | Fair | 19 | Excellent | Fair |
| Example 9 | | | | | |
| Comparative | Excellent | Fair | 19 | Excellent | Good |
| Example 10 | | | | | |
| Comparative | Excellent | Excellent | 9 | Fair | Good |
| Example 11 | | | | | |
| Comparative | Good | Fair | 30 | Excellent | Good |
| Example 12 | | | | | |
| Comparative | Excellent | Excellent | 7 | Fair | Good |
| Example 13 | | | | | |
| Comparative | Excellent | Excellent | 22 | Excellent | Poor |
| Example 14 | | | | | |
| Comparative | Excellent | Good | 21 | Excellent | Poor |
| Example 15 | | | | | |
| Comparative | Good | Fair | 14 | Good | Good |
| Example 16 | | | | | |
| Comparative | Good | Fair | 12 | Good | Poor |
| Example 17 | | | | | |
| Comparative | Excellent | Fair | 21 | Excellent | Good |
| Example 18 | | | | | |
| Comparative | Excellent | Good | 20 | Excellent | Poor |
| Example 19 | | | | | |

Table 3 reveals the following. Toners of Practical Examples 1 to 17, which used the first resin fine particles with a number average primary particle size of 60 nm or more but 100 nm or less, an SP value of 9.42 or more but 9.80 or less, a degree of hydrophobization of 5% or more but 16% or less, and a coverage ratio with respect to the surface region of the toner base particle of 5% or more along with the second resin fine particles with a number average primary particle size of 30 nm or more but 50 nm or less, an SP value of 8.70 or more but 9.40 or less, a degree of hydrophobization of 18% or more, and a coverage ratio with respect to the surface region of the toner base particle of 5% or more but 25% or less, and in which the first and second resin fine particles had a hardness of 1 μN or more, were good or excellent (practically satisfactory) in all of the rise of the charge amount, toner scattering, and drum cleaning properties.

In contrast, as clearly shown in Table 4, toner of Comparative Example 1, to which neither the first nor the second resin fine particles were externally added, was poor in electrical conduction between the carrier and the toner particles, and thus it exhibited, in the ultra-low humidity environment, a slow rise of the charge amount.

With toner of Comparative Example 2, to which the first resin fine particles alone were externally added, after durability printing, the first resin fine particles sank in the toner base particle, and thus electrical conduction between the carrier and the toner particles was poor, resulting in a slow rise of the charge amount in durability printing. On the other hand, with toner of Comparative Example 3, to which only the second resin fine particles with high hydrophobicity were externally added, electrical conduction between the carrier and the toner particles was poor, resulting in, from the initial stage of use, a slow rise of the charge amount.

In toner of Comparative Example 4, which used the first resin fine particles with a coverage ratio below the lower limit value, after durability printing, the first resin fine particles sank in the toner base particle, and thus electrical conduction between the carrier and the toner particles was poor, resulting in a slow rise of the charge amount in durability printing. On the other hand, with toner of Comparative Example 5, which used the second resin fine particles with a coverage ratio below the lower limit value, the second resin fine particles were less effective as a spacer, so that the first resin fine particles sank in the toner base particle, and thus electrical conduction between the carrier and the toner particles was poor, resulting in a slow rise of the charge amount.

With toner of Comparative Example 6, which used the second resin fine particles with a coverage ratio more than the upper limit value, the surface of the toner base particle had a smaller area to have the first resin fine particles fixed to it. As a result, more of the first resin fine particles came off, resulting in poor drum cleaning properties.

With toner of Comparative Example 7, which used the first resin fine particles with an SP value below the lower limit value, the first resin fine particles and the toner base particle had low compatibility. As a result, more of the first resin fine particles tended to come off the toner base particle, resulting in poor drum cleaning properties. On the other hand, with toner of Comparative Example 8, which used the first resin fine particles with an SP value more than the upper limit value, the first resin fine particles and the toner base particle had high compatibility. As a result, after durability printing, more of the first resin fine particles tended to sink in the toner base particle, and thus electrical conduction between the carrier and the toner particles was poor, resulting in a slow rise of the charge amount in durability printing.

With toner of Comparative Example 9, which used the second resin fine particles with an SP value below the lower limit value, the second resin fine particles and the toner base particle had low compatibility. As a result, more of the second resin fine particles tended to come off the toner base particle, resulting in poor drum cleaning properties. In addition, the coming-off of the second resin fine particles made them less effective as a spacer, and thus electrical conduction between the carrier and the toner particles was poor, resulting in a slow rise of the charge amount in durability printing. On the other hand, with toner of Comparative Example 10, which used the second resin fine particles with an SP value more than the upper limit value, the second resin fine particles and the toner base particle had high compatibility. As a result, the second resin fine particles sank in the toner base particle, so that they were less effective as a spacer; thus, after durability printing, more of the first resin fine particles tended to sink in the toner base particle, and thus electrical conduction between the carrier and the toner particles was poor, resulting in a slow rise of the charge amount in durability printing.

With toner of Comparative Example 11, which used the first resin fine particles with a degree of hydrophobization below the lower limit value, and toner of Comparative Example 13, which used the second resin fine particles with a degree of hydrophobization below the lower limit value, their volume resistance values were so low in a high humidity environment that it was difficult to maintain charge for the toner charge amount, resulting in a reduced toner charge amount. On the other hand, with the toner of Comparative Example 12, which used the first resin fine particles with a degree of hydrophobization more than the upper limit value, electrical conduction between the carrier and the toner particles was poor, resulting in a slow rise of the charge amount.

With toner of Comparative Example 14, which used the first resin fine particles with a hardness below the lower limit value, and toner of Comparative Example 15, which used the second resin fine particles with a hardness below the lower limit value, the resin fine particles formed a film on the surface of the photosensitive drum. This caused unstable stick-slip movement of the cleaning blade, resulting in poor drum cleaning properties.

With toner of Comparative Example 16, which used the first resin fine particles with a number average primary particle size below the lower limit value, after durability printing, more of the first resin fine particles tended to sink in the toner base particle, and thus electrical conduction between the carrier and the toner particles was poor, resulting in a slow rise of the charge amount in durability printing. On the other hand, with toner of Comparative Example 17, which used the first resin fine particles with a number average primary particle size more than the upper limit value, the first resin fine particles were difficult to fix to the surface of the toner base particle. As a result, more of the first resin fine particles tended to come off the toner base particle, resulting in poor drum cleaning properties.

With toner of Comparative Example 18, which used the second resin fine particles with a number average primary particle size below the lower limit value, the second resin fine particles were less effective as a spacer, so that more of the first resin fine particles tended to sink in the toner base particle. As a result, electrical conduction between the carrier and the toner particles was poor, resulting in a slow rise of the charge amount in durability printing. On the other hand, with toner of Comparative Example 19, which used the second resin fine particles with a number average primary particle size more than the upper limit value, the second resin fine particles were difficult to fix to the surface of the toner base particle. As a result, more of the second resin fine particles tended to come off the toner base particle, resulting in poor drum cleaning properties.

The above results confirm the following. Setting, with respect to each of the first and second resin fine particles, the number average primary particle size, the hardness, the SP value, the degree of hydrophobization, and the coverage ratio with respect to the surface region of the toner base particle within appropriate ranges allows production of toner that excels in terms of the rise of the charge amount at the start of printing and after durability printing, toner scattering, and drum cleaning properties.

The present disclosure finds application in positively chargeable toner for use in an electrophotographic method, and in two-component developer containing such positively chargeable toner. Based on the present disclosure, it is possible to provide positively chargeable toner that can ensure a quick and stable rise of the charge amount even in an ultra-low humidity environment and that permits the formation of a high-quality image for a long period, and to provide two-component developer containing such positively chargeable toner.

What is claimed is:

1. Positively chargeable toner comprising toner particles each comprising:
a toner base particle; and
an external additive attached to a surface of the toner base particle,
wherein
the external additive contains:
a first resin fine particle with a number average primary particle size of 60 nm or more but 100 nm or less; and
a second resin fine particle with a number average primary particle size of 30 nm or more but 50 nm or less,
the first and second resin fine particles have a hardness of 1 μN or more as measured with a probe displacement of 40 nm,
the first resin fine particle has an SP value of 9.42 or more but 9.80 or less, a degree of hydrophobization of 5% or more but 16% or less, and a coverage ratio with respect to a surface region of the toner base particle of 5% or more, and
the second resin fine particle has an SP value of 8.70 or more but 9.40 or less, a degree of hydrophobization of 18% or more, and a coverage ratio with respect to the surface region of the toner base particle of 5% or more but 25% or less.

2. The positively chargeable toner according to claim 1, wherein
the first and second resin fine particles are formed of a polymer of a styrene-based monomer, an acrylic acid-based monomer, and a cross-linking agent and is surface-treated with a surfactant.

3. The positively chargeable toner according to claim 2, wherein
the surfactant is a cationic surfactant.

4. Two-component developer comprising:
the positively chargeable toner according to claim 1; and
carrier by friction with which the positively chargeable toner is positively chargeable.
